(19) United States
(12) Patent Application Publication
(10) Pub. No.: US 2009/0164346 A1
(43) Pub. Date: Jun. 25, 2009

(54) Fund Transfers Using Multiple Accounts

(76) Inventors: Reinhold Loevenich, Sandhausen (DE); Ulrich Haenle, Wiesloch (DE); Mathias Sonnek, Oberhausen-Rheinhausen (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/960,679

(22) Filed: Dec. 19, 2007

(51) Int. Cl. G06Q 10/00

(52) U.S. Cl. 705/30

(57) ABSTRACT

The subject matter disclosed herein provides methods and apparatus, including computer program products, for fund transfers using multiple accounts associated with internal positions for the funds. In one aspect, there is provided a computer-implemented method. The method may receive an indication representing a financial instrument. A plurality of accounts may be generated. The generated plurality of accounts may provide internal positions for the financial instrument. Another account may provide an external position for the financial instrument. The external position and the internal position may be maintained to enable an accounting of the financial instrument. Related apparatus, systems, methods, and articles are also described.

### FIELD

The subject matter disclosed herein relates treasury management.

### BACKGROUND

Treasury management refers to managing the financial resources of an entity. A treasury management system provides a mechanism to manage those financial resources. To manage a treasury, a treasury management system may include one or more of the following features: report generation, financial transaction management, accounting, audits, cash management, risk analysis, and the like. For example, when an entity purchases a financial instrument, such as a security, information describing the transaction is provided to the treasury management system. The treasury management system may then generate reports (e.g., profit and loss statements), manage any receipts from the security (e.g., a dividend or a sale), provide accounting information regarding the transaction to enable accounting, and the like.

The treasury management system may include accounting features that maintain a general ledger and a subledger. A general ledger is considered an entity's central “books” through which every transaction flows. These records maintain all financial transactions associated with the entity. The two primary financial reports of any company are their balance sheet and the profit and loss statement, and both of these are drawn directly from the company's general ledger. Subsidiary ledgers (also referred to as subledgers) may also be maintained by the treasury management system. The subledgers may keep track of items such as cash, accounts receivable, and accounts payable. Entries entered (i.e., posted) to these subledgers will transact through the general ledger account. For example, when a credit sale posted in the account receivable subledger turns into cash due to a payment, the transaction will be posted to the general ledger and the two subledgers (e.g., cash and accounts receivable) as well.

### SUMMARY

The subject matter disclosed herein provides methods and apparatus, including computer program products, for fund transfers using multiple accounts.

In one aspect, there is provided a computer-implemented method. The method may receive an indication representing a financial instrument. A plurality of accounts may be generated. The generated plurality of accounts may provide internal positions for the financial instrument. Another account may provide an external position for the financial instrument. The external position and the internal position may be maintained to enable an accounting of the financial instrument.

In some implementations, the subject matter described herein provides the advantage of tracking internal positions associated with internal funds.

Articles are also described that comprise a computer-readable medium (e.g., tangibly embodied machine-readable medium) operable to cause one or more machines to result in operations described herein. Similarly, a system (e.g., a computer) is described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

In the drawings,

FIG. 1 shows a block diagram of a system for treasury management;

FIG. 2 shows an example of a transaction including multiple accounts for multiple funds internal to an organization;

FIG. 3 shows a process for generating multiple accounts for the internal positions associated with the multiple funds; and

FIGS. 4A-4B show examples of cash flows including internal and external positions.

Like reference symbols in the various drawings indicate like elements.

### DETAILED DESCRIPTION

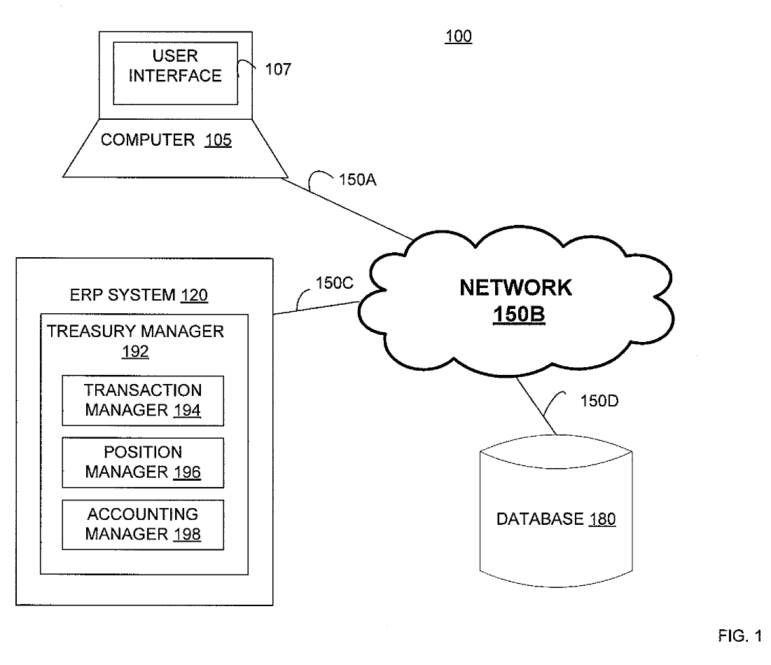

FIG. 1 depicts a block diagram of a system 100 including a computer 105 (e.g., a computer, a processor, and the like), an ERP (enterprise resource planning) system 120, a database 180, and a network 150A-D.

The computer 105 further includes an application, such as a user interface 107. The user interface 107 may be any application used to interface with other applications, such as ERP system 120. User interface 107 may include a browser or a client application to interface with applications and services. In some implementations, user interface 107 may be used to provide to ERP system 120 information describing a transaction.

ERP system 120 may include one or more components (e.g., applications, services, applets, and the like) to provide an integrated system for the data and processes of an enterprise (e.g., an entity). The ERP system 120 further includes a treasury manager 192, including a transaction manager 194, a position manager 196, and an accounting manager 198.

Treasury manager 192 may include one or more components (e.g., applications, services, applets, and the like) to manage a treasury. Treasury refers to the funds of an entity, such as a business, a government institution, an organization (e.g., a non-profit corporation), an individual, and the like. Treasury manager 192 receives an indication representing a financial instrument. The financial instrument may correspond to money, a loan, an asset, a money market, a security (e.g., bonds, stocks, and the like), a derivative, a debit, and any other transaction or security interest. The indication may represent information describing the financial instrument. For example, the indication may be provided by user interface 107 and include information regarding the transaction, such as account assignment information (also referred to herein as account elements, account relevant information, and position relevant information). An example of account assignment information is a fund center or cost center of the financial instrument, a brokerage account number, a loan number, and other information describing the transaction or the financial instrument (e.g., information qualifying entries in a general ledger).

Transaction manager 194 handles transactions associated with any indication representing financial instruments received by treasury manager 192. Specifically, transaction manager 194 may be used to complete information regarding the transaction (e.g., generate account assignment information, payment details, and the like) before transferring the transaction to accounting manager 198 for posting. For example, transaction manager 194 may provide a template including account assignment information (e.g., account elements) to enable the user of user interface 107 to provide information associated with the transaction.

In some implementations, transaction manager 194 may be used in connections with public sector entities, such as universities, non-profit corporations, non-governmental organizations, government institutions, and the like. In the public sector area, a fund represents the origin, such as the source, of money or a financial instrument. A fund may represent a separate and distinct fiscal (e.g., accounting) object including a complete self-balancing set of accounts used to monitor the use of the financial resources (e.g., cash) of an organization, together with associated liabilities, residual equities, and related changes. Amounts may be distinguished by fund so that certain activities can be performed or objectives achieved in accordance with special regulations, restrictions, or limitations. A fund may thus have restrictions on possible uses of the fund. For example, a university may receive a financial instrument (e.g., through an endowment) and the fund may have restrictions on the use of the financial instrument to a particular purpose, such as only at the business school or only for a particular scholarship. When this is the case, transaction manager 194 may, using position manager 196, perform one or more of the following: control transactions associated with the fund of the public sector entity organization; generate a complete financial statement for the fund; ensure that the use of the fund can always be tracked and thus traced; and provide information to accounting manager 198 to make appropriate posting to a balance sheet, cash flow statement, and the like. In some cases, the funds define, from an accounting point of view, a so-called “subledger position.”

A cash flow provided by transaction manager 194 or accounting manager 198 may represent a so-called “real” cash flow with an external entity. For example, the real cash flow may correspond to receiving the proceeds of a loan and paying principal and interest on that loan or purchasing a security and receiving dividends on that security as well as determining the present value of that security at any given time.

In some implementations, transaction manager 194 may inhibit the assignment of a financial transaction to account elements. Account elements may refer to information describe the financial instrument. For example, a public sector entity may enter into a contract deal for a financial instrument, such as a bond, a money market, a security, a derivative, and the like, for a plurality of funds. In this case, transaction manager 194 provides two views on the contract—an external position treating the contracted transaction as a single position (e.g., between the public sector entity and the provider of the financial instrument) and a plurality of internal positions for each of the funds participating in the contracted transaction in the financial instrument.

Since positions are identified by account element, a purchase of a financial instrument may affect or create several positions. Moreover, any changes associated with a security may only need to be based on external positions (e.g., conditions like interest, dividend, or repayments). The cash flows are then split according to the ratio of the corresponding internal positions to show the internal view within a sub-ledger at system 100. For example, if an external position includes two internal positions each with a 50% interest, the external position would be attributed to each of the internal positions based on the 50%.

Position manager 196 may be used to generate a plurality of accounts to provide internal positions for a plurality of funds associated with a financial instrument. For example, a public sector entity may generate a plurality of accounts, each of which corresponds to a fund internal to the public sector entity. These accounts provide internal positions on these internal funds to enable tracking and tracing of the funds. Position manager 196 may also map the plurality of accounts representing internal positions to an external position, such as a single external position for the financial transaction. The external position represents a position of the entity with respect to the financial institution providing the financial instrument. Moreover, the external position may be used to generate profit and loss statements and other reports provided to external organizations, such as the Internal Revenue Service and the Securities and Exchange Commission (SEC).

Position manager 196 may provide the flexibility to arrange cash flows according to internal requirements, such as based on funds and sub-ledger positions. Position manager 196 may also provide valuation processes (e.g., a security price valuation, an accrual, a deferral, an amortization, and the like). In some implementations, information regarding the financial instrument may be received at position manager 196 from transaction manager 194 rather than from a user interface.

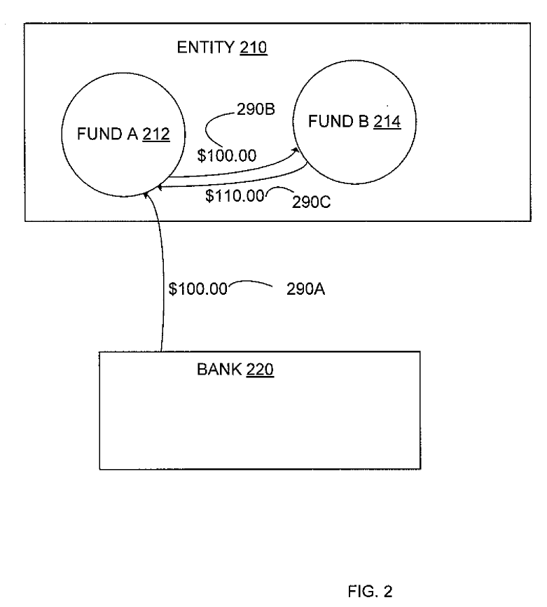

FIG. 2 depicts an example transaction including internal positions and external positions. A financial institution, such as bank 220, may loan $100.00 290A to entity 210. From the perspective of bank 220 and entity 210, the external position is a loan of $100.00. Entity 210 may generate a plurality of accounts “A′ and “B,” such as fund A 212 and fund B 214. These accounts provide internal positions for the loan $100.00 290A. In the example of FIG. 2, the internal position corresponds to a loan of $100.00 to fund A 212. This internal position is also provided to accounting manager 198 to make appropriate accounting entries.

At some point after the loan is received, fund A 212 transfers the cash of the loan, so that fund B 214 receives $100.00 290B and fund A 212 receives a promise from fund B 214 to repay the loan with interest (e.g., $110.00 290C). From the perspective of bank 220 and entity 210, the external position is unchanged, i.e., a loan of $100.00 with a promise of repayment including interest. However, the internal positions of fund A 212 and fund B 214 have changed. Position manager 196 maintains whether the positions are internal or external, so that transaction manager 194 and accounting manager 198 may properly handle these positions. For example, position manager 196 may map (e.g., associate) accounts A and B of funds 212 and 214 to the external position of entity 210, so that transaction manager 194 may make principal and interest payments on the loan with bank 220. Although the above example describes accounts as A and B, any other identifier may be used as well.

Although FIG. 2 depicts an example of a loan, any other financial instruments may be used as well. Moreover, although FIG. 2 depicts bank 220, any other entity may be used as well.

Referring again to FIG. 1, accounting manager 198 may make accounting entries for the positions according to generally accepted accounting standards. In some cases, accounting manager 198 may generate, based on the external positions only, a cash flow statement and a profit and loss statement. On the other hand, internal positions being tracked but may not necessarily affect such statements. For example, if fund A 212 and fund B 214 repeat the transaction 290B and 290C that would not impact the cash flow or profit and loss of entity 210 since the “external position” with respect to bank 220 would remain the same.

Although FIG. 1 depicts ERP system 120, any other application may be used as well including a customer relationship management (CRM) application, a product lifecycle management application, a supply chain management (SCM) application, and a supplier relationship management application. Although FIG. 1 depicts ERP system 120, computer 105, and database 180 at separate locations, in some implementations, ERP system 120, computer 105, and database 180 may be at other locations and/or distributed among multiple locations.

Database 180 may include financial data and information describing the financial instruments, account relevant information, internal position information, external position information (e.g., external account information), rules to map between the external position and one or more internal positions, account numbers associated with the funds and their corresponding internal positions, and any other account relevant information describing the financial instrument, transaction, user, and the like.

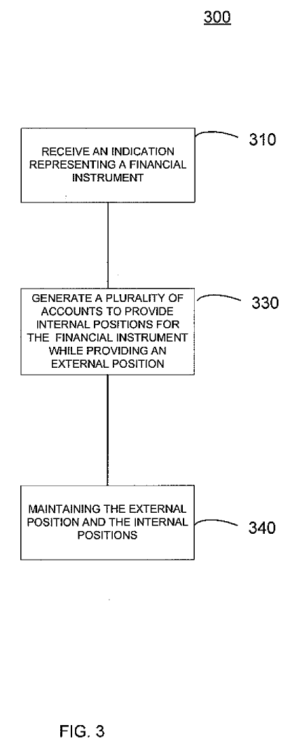

FIG. 3 shows a process 300 for generating a plurality of accounts.

At 310, an indication representing a financial instrument may be received at ERP system 120. For example, the indication may include information describing the transaction. This account relevant information may be provided by user interface 107 or may be received by other mechanisms, such as from another system.

In some implementation, user interface 107 includes tables provided by transaction manager 194 and/or position manager 196. The table serves as a template to enable a user to insert account relevant information describing the financial instrument. This account relevant information is provided to transaction manager 194, where the information is maintained as account elements of the financial instrument (or the transaction associated with that financial instrument). An account element may be classified based on whether it affects a balance sheet account or whether it affects a profit or loss posting. The account elements may be entered by a user, provided by another processor, and may be provided by system 100 as a so-called default value.

Examples of accounting elements include whether the financial instrument (or associated transaction) corresponds to a fund or a grant. The fund and grant account elements may be initially provided (e.g., by user interface 107, transaction manager 194, position manager 196, or by another processor or interface) when the financial instrument is first generated, or created, at system 100. Moreover, the fund and grant account elements may be considered relevant to a sub-ledger position. A grant refers to an instrument used to establish a funding relationship between a sponsor (i.e., the grantor) and grantee to carry out a public purpose of support or a stimulation in which the sponsor does not expect to be substantially involved. A grant may be for any purpose and may cover all or only part of the costs of a project. The grant as an object may have a finite lifecycle, divided into stages.

Other examples of account elements include a commitment item, a fund center, and a funded program. These latter three account elements may be used by position manager 196 to track the fund. Additional examples of account elements include: a functional area, a cost center, a company code identifying a company, a deal number, a security ID, a financial instrument category (according to International Financial Accounting Standards 39 §9 and Financial Accounting Standard 133), a security account (e.g., a user account number at a broker), a portfolio, a lot ID identifying the lot, and a position account (e.g., of a financial future).

When the transaction corresponds to a security, user interface 107 may be used to provide a plurality of account elements. The accounting elements associated with a financial instrument may be relevant to a position controlled by position manager 196. These position relevant elements may define aspects of the financial instrument. These position relevant elements may be describe the actual interest that a fund has in a deal. For example, the position relevant elements may be defined as fractional values, a nominal amount (e.g., a face value), a unit, a payment amount, or a percentage. When a percentage used, a rounding difference error may occur, which system 100 may provide a stable and traceable algorithm to sort the fractions and any rounding differences.

At 330, a plurality of accounts may be generated to provide internal positions for the financial instrument, while providing an external position for the financial instrument. Moreover, a mapping may be maintained by position manager 196. The mapping enables transaction manager 194 and position manager 196 to attribute a transaction to an account, such as accounts associated with internal positions and a corresponding external account. These mapping may also include information, such as rules describing whether a transaction affects the external position (e.g., profit and loss statements) or whether a transaction affects only an internal position. Although mapping of internal to external position is described as a position manager 196 task, in some implementations, transaction manager 194 performs that mapping.

At 340, the internal positions and external positions are maintained. For example, system 100 may maintain these positions and provided the maintained information to accounting manager 198 to make appropriate accounting entries as well as generate reports.

While these positions are maintained, accounting manager 198 may use one or more amortization procedures. When this is the case, the consequences of a transaction, such as a transfer of the financial instrument, may differ for positions with different amortization procedures. If a position has a so-called scientific amortization procedure (SAC procedure) including interest payments, the amortization takes care of accrued interest, so additional accrual runs are not necessary.

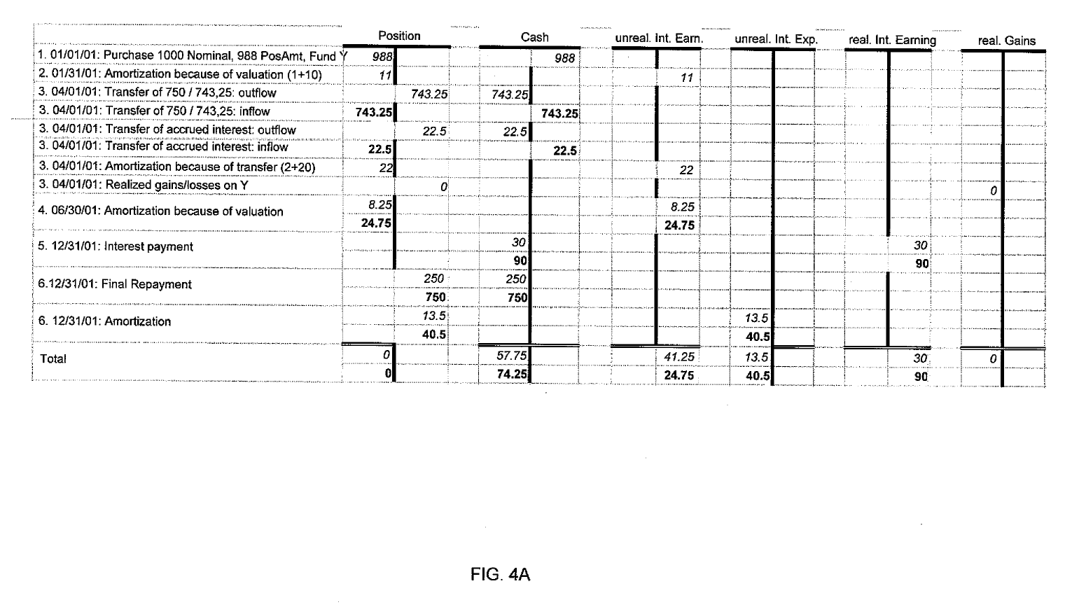

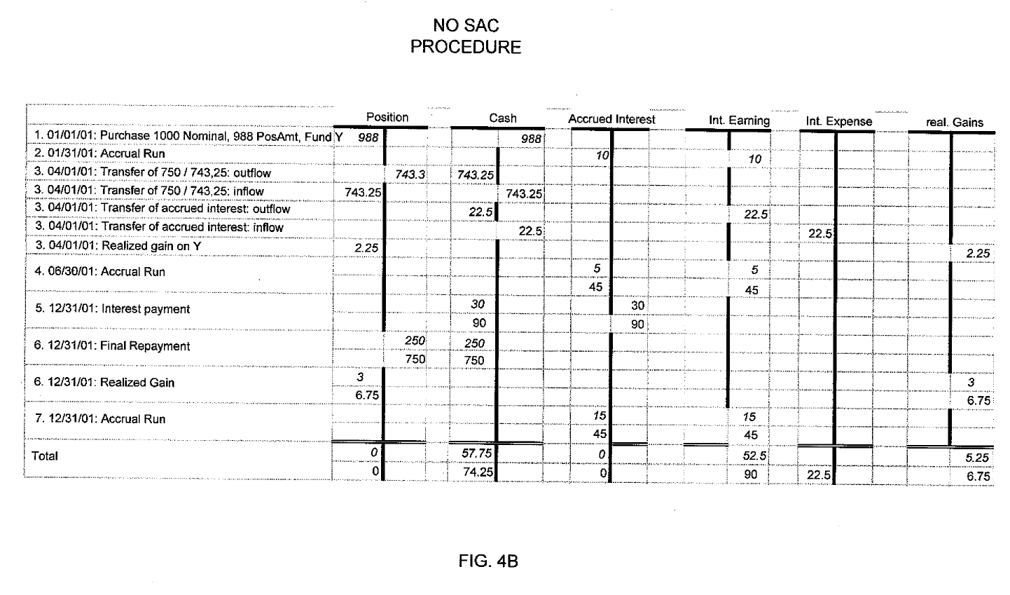

FIG. 4A depicts a fund transfer using a SAC procedure, while FIG. 4B depicts an example without the SAC procedure. Referring to FIGS. 4A and 4B, a bond pays yearly interest of 10% at the end of December. On Dec. 31, 2001, the final repayment is due. In FIGS. 4A and 4B, the following transactions take place:
1. Purchase of $1000 nominal amount (i.e., face value of the bond is $1000) for $988 at Jan. 01, 2001 for fund Y (indicated by text in italic) as the purchase is on the first day of a new interest rate period there is no accrued interest;
2. Valuation or accruals run on Jan. 31, 2001;
3. Transfer of $750 nominal amount from fund Y to fund G (indicated by text in bold) on Mar. 01, 2001 (this means that a quarter of the interest period is over); so that the position (and payment) amount of the transfer is $743.50;
4. Valuation or accruals run on Jun. 30, 2001;
5. Interest payment on Dec. 31, 2001;
6. Final repayment on Dec. 31, 2001; and
7. Valuation or accruals run on Jun. 30, 2001.
   The positions of fund Y (in italics) and fund G (in bold) including cash, unrealized interest earnings (labeled “unrel. Int. Earn.”), unrealized interest expense (labeled “unreal. Int. Exp.), realized interest earnings (labeled “real. Int. Earning), and realized gains (labeled “real. Gain) are different based on whether SAC amortization is used by accounting manager 198.

The following is another example of a deal where the financial instrument is a money market. The system 100 assigns multiple sets of position relevant elements as in the case of other transactions, such as a securities transaction. Fractions for each set of position relevant elements may be specified by a nominal amount, a payment amount, or a percentage. The assignment of multiple sets of position relevant elements to money market deals is more complicated than in the case of securities as a money market deal covers most cash flows of a corresponding position, while a security deal captures only one change in the position. The system 100 assigns multiple sets of elements to each flow that change the nominal amount of the deal except repayments and capitalized interest. The user at user interface 107 may not be allowed to enter position relevant elements for repayments and all other condition based flows as position manager 196 may determine and provide these elements. The following provides an example of an assignment of position relevant elements, by position manager 196, to flows for money market deals:
1. The user of user interface 107 creates a fixed term deposit of $10,000 for three months; fund A participates with $4,000 and fund B with $6,000; at the end of the term, the deal pays back $10,000 and $300 interest, i.e., $100 for every month.
2. After one month, fund C joins the deal with an additional $10,000; this means that at the end of term the bank pays $20,000 and $500 interest.

The above money market deal example shows that the user at user interface 107 must be able to enter sets of position relevant elements (e.g., a term of 3 months, a face value of $10,000, participating amount of fund A, participating amount of fund b, addition of fund C and its participating amount, etc.) for the initial investment as well as for subsequent increases. Moreover, position manager 196 has to show three positions for the deal (i.e., one for each participating fund). As such, the cash flow for fund A includes the following: an investment of $4,000.00; a repayment of $4,000.00; a total interest of $120.00 ($40.00 for each month). The interest may be split into several flows. In this example, the user expects two flows, one for the first month and another for the two last months. The cash flow for fund B is analogous with investment and repayment of $6,000.00 and a total interest of $180.00. The position for fund C has to show the following flows: an investment of $10,000, a repayment of $10,000; and an interest of $200. Every cash flow changing a nominal amount (except repayments and capitalized interest) has to carry the information about the position relevant elements. If the user entered these elements when the deal was created at system 100 (e.g., transaction manager 194 or position manager 196), these values serve as a proposal. The user of user interface 107 may change the proposed values and add multiple sets of position relevant elements, although some values may be inhibited by position manager 196. The position manager 196 may instead provide some information and splits flows if necessary. The split should be according to the ratio of positions with different position relevant elements at the calculation date of the respective case flow.

In some implementations, in the case of a fund transfer, user interface 107 may be used to change the distribution among participating funds without changing the external position, such as the cash flow.

In the case of a money market or a security, these financial instruments may be transferred at user interface 107 as a partial transfer. For example, an external security position of nominal $10,000.00 might belong with $4,000 to fund A and with $6,000 to fund B. User interface 107 may be used to transfer $2,000 from fund B to another fund C, so that after the transfer funds A and B have $4,000 while fund C has $2,000. Although the fund transfer does not change the external cash flow, the fund transfer is cash relevant for the funds A, B, and C. After the transfer, the selling party has cash available and the buying party has less cash. This is in contrast to other transfers of financial instruments within an organization, which are not cash relevant. Transfers usually occur at book value. In these cases, user interface 107 specifies the transferred quantity, i.e. nominal amount or units. The system 100 then determines the transferred amounts as book values. However, for a fund transfer, user interface 107 may specify a quantity and a payment amount, because in this case even within an organization it may be reasonable to negotiate the price of the exchanged portion of a financial instrument.

In some implementations, system 100 determines interest associated with the financial interest. For example, when trading securities, it is common practice to calculate accrued interest and show it explicitly in the transaction. Even though a bank is not involved in the fund transfer, accrued interest should be calculated in the same way and be part of the transaction between funds. Within a fund transfer, money market deals may be treated similar to security deals and therefore accrued interest may be shown. In both cases, accrued interest and the actual transfer may not appear in the operative cash flow (provided by transaction manager 194), but instead appears in position manager 196. This ensures that there is always a consistent view on the external cash flow as well as on the internal cash flow.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. Although FIG. 1 depicts network 150A-D, components of system 100 may be interconnected by any form or medium of communication, example of which include point-to-point links, a bus, a local area network (“LAN”), a wide area network (“WAN”), an intranet, and the Internet.

The foregoing description is intended to illustrate but not to limit the scope of the invention, which is defined by the scope of the appended claims. Other embodiments are within the scope of the following claims.

What is claimed:

1. A computer-implemented method comprising:
receiving an indication representing a financial instrument;
generating a plurality of accounts to provide internal positions for the financial instrument and another account to provide an external position for the financial instrument; and
maintaining the external position and the internal position to enable an accounting of the financial instrument.

2. The computer-implemented method of claim 1, wherein receiving the indication further comprises:
receiving, from a user interface, a message including account elements describing the financial instrument.

3. The computer-implemented method of claim 1, wherein generating further comprises:
generating a first account for a first fund and a second account for a second fund, the first and second fund representing internal positions of an entity.

4. The computer-implemented method of claim 3 further comprising:
mapping the first account and the second account to the other account corresponding to the external position.

5. The computer-implemented method of claim 1 further comprising:
providing, to a user interface, a template of account elements to enable a user to provide information describing the financial instrument.

6. The computer-implemented method of claim 1, wherein maintaining further comprises:
maintaining the external position and the internal position to enable generation of at least one of a cash flow statement and a profit and loss statement.

7. A computer-readable medium comprising instructions that when performed by a computer result in operations comprising:
receiving an indication representing a financial instrument;
generating a plurality of accounts to provide internal positions for the financial instrument and another account to provide an external position for the financial instrument; and
maintaining the external position and the internal position to enable an accounting of the financial instrument.

8. The computer-readable medium of claim 7, wherein receiving the indication further comprises:
receiving, from a user interface, a message including account elements describing the financial instrument.

9. The computer-readable medium of claim 7, wherein generating further comprises:
generating a first account for a first fund and a second account for a second fund, the first and second fund representing internal positions of an entity.

10. The computer-readable medium of claim 9 further comprising:
mapping the first account and the second account to the other account corresponding to the external position.

11. The computer-readable medium of claim 7 further comprising:
providing, to a user interface, a template of account elements to enable a user to provide information describing the financial instrument.

12. The computer-readable medium of claim 7, wherein maintaining further comprises:
maintaining the external position and the internal position to enable generation of at least one of a cash flow statement and a profit and loss statement.

13. A system comprising:
a processor; and
a memory, wherein the processor and the memory are configured to perform a method comprising:
receiving, at a transaction manager, an indication representing a financial instrument;
generating, at a position manager, a plurality of accounts to provide internal positions for the financial instrument and another account to provide an external position for the financial instrument; and
maintaining the external position and the internal position to enable an accounting of the financial instrument.

14. The system of claim 13, wherein receiving the indication further comprises:
receiving, from a user interface, a message including account elements describing the financial instrument.

15. The system of claim 13, wherein generating further comprises:
generating a first account for a first fund and a second account for a second fund, the first and second fund representing internal positions of an entity.

16. The system claim 15 further comprising:
mapping the first account and the second account to the other account corresponding to the external position.

17. The system of claim 13 further comprising:
providing, to a user interface, a template of account elements to enable a user to provide information describing the financial instrument.

18. The system of claim 13, wherein maintaining further comprises:
maintaining the external position and the internal position to enable generation of at least one of a cash flow statement and a profit and loss statement.
